(19) United States
(12) Patent Application Publication
(10) Pub. No.: US 2004/0104784 A1
(43) Pub. Date: Jun. 3, 2004

(54) Wide area network as applied to switchyard/substation control design

(76) Inventor: Ishmael Enriquez, Austin, TX (US)

Correspondence Address: ISHMAEL ENRIQUEZ, 5714 HONEYBEE BEND, AUSTIN, TX, 78744, US

(21) Appl. No.: 10/299,076

(22) Filed: Nov. 19, 2002

(51) Int. Cl. H01P 5/00

(52) U.S. Cl. 333/24 R; 340/870.01; 340/310.01; 307/11; 709/238

(57) ABSTRACT

This document contains a specification for a substation relaying and control wide area network based on a SONET or possibly a T Carrier (Small Site) communication concept. At this level every device at the substation, plant or any place where control of high voltage (600 Volts and above) equipment, can be networked. Every secondary signal can be digitized for control, alarm, and indication. SCADA equipment can be interfaced or replaced with this concept. Metering equipment can be interfaced to SONET Protocol without actual secondary values at inputs to control house meter. Panel device(s) footprint will be reduced thereby reducing the control housing dimensions. Stub-up conduit quantity for the power equipment will be reduced thereby reducing labor and material costs. Inventory stock will be reduced thus minimizing storage fees. Reliability and security will be increased. Fault monitoring will be simplified. Surveillance will be more practical. Site to site communications can be approached with leased satellite space as optional communications. Much quicker relay response time to actual fault. All these are a benefit to this design concept.

### FEDERALLY SPONSORED RESEARCH

Not Applicable

### SEQUENCE LISTING OR PROGRAM

Not Applicable

### BACKGROUND

### Description of Prior Art

The “Control System for An Electrical Power Line” in U.S. Pat. No. 3,852,532 to Giles et al. 1974 Dec. 3, had an application to a local and remote site via an analogue signal. This kind of application needed the aid of other relay(s) to protect a line that was, for the most part, electrical mechanical in nature. The “Control And Self-Monitoring System, In Particular For A Multiple Electrical Apparatus Such As A High Tension Circuit Breaker” in U.S. Pat. No. 5,384,678 to Ebersohl et al., 1995 Jan. 24, was an improvement in the use of then current technology, to the protection control of high voltage devices, such as breakers. Further, monitoring and fault protection devices such as “Monitoring and Fault Protection of High Voltage Switch Yards” in U.S. Pat. No. 5,408,176 to Blatt, 1995 Apr. 18, was patented to improve system performance derived from then “state-of-the-art” technology. In 1996 Feb. 13, the “Power Line Communicated System” was U.S. patented to Sargeant et al. This communicated via the power link itself, but still required other relays via hardwired copper size number ten (10) or number twelve (12) conductor for control and often times number eight (8) conductor for long circuit runs. Another U.S. Pat. No. 5,859,596 McRae, 1999 Jan. 12, “Switchyard Equipment Monitoring System and Communications Network Therefor” introduced a power line communication system dependent on signals transmitted and received via the power line. This particular patent demonstrates that a computer can exist in the switchyard. These improvements in the electric industry communications led to the next step in switchyard communications. My invention is an application of communications with a digital solution at the switchyard level.

There have been other protection and control patents, not mentioned here, that touch on using either fiber (SONET) or microwave to communicate from site to site. My invention lends to applying fiber or 22 AWG copper wires to every piece of equipment in the yard. A synchronous communicated switchyard is a wide area network (WAN). For reason of security coupled with dependability and reliability relay engineers have long been reluctant to fully implement a fully digital solution to relay protection. My invention addresses these concerns and affords these areas, with promise.

### SUMMARY OF INVENTION

My invention introduces fiber or 22 AWG copper wires to the switchyard equipment from the control house. It creates an interface between equipment at the switchyard high voltage equipment and equipment in the control house through a WAN. It would require current relay technology modifications to include at least a T1 network interface card. My design includes a device that would convert a T1 protocol to an RS-232 serial interface used extensively in current relay technology. This invention eliminates the larger 30 ampere conductor reducing the installation to supply cable (AC and/or DC) and two communication links for control, one primary and one backup. The network processor ensures communication connectivity by switching from primary to backup fiber in the event of a communication failure. Another fiber link assures a separate and complete alarm and indication (optional) system from the control (and indication optional) fiber link. In the switchyard equipment a device will ensure OVERCURRENT protection in the event of network processor maintenance down time. These communication links isolate control house controls from switchyard controls, but integrate them through the fiber links. At the control house panel, this design reduces the need for a large 30 ampere switching control device(s) to one (1) ampere continuous rating. It reduces the footprint of these switching control device(s) making the panel real estate accommodate a larger control device(s) density. A substation with four (4) 40 MVA power transformers loaded at 80% of maximum line loading at 138 kV would allow all controls onto one simplex panel.

### DRAWINGS

### Drawing Figs.:

The following drawings detail certain aspects of my invention. A complete system description would necessitate many drawings showing very fine detail to the hardware level. However, the following drawings detail enough of information for an individual trained in the art to understand the invention:

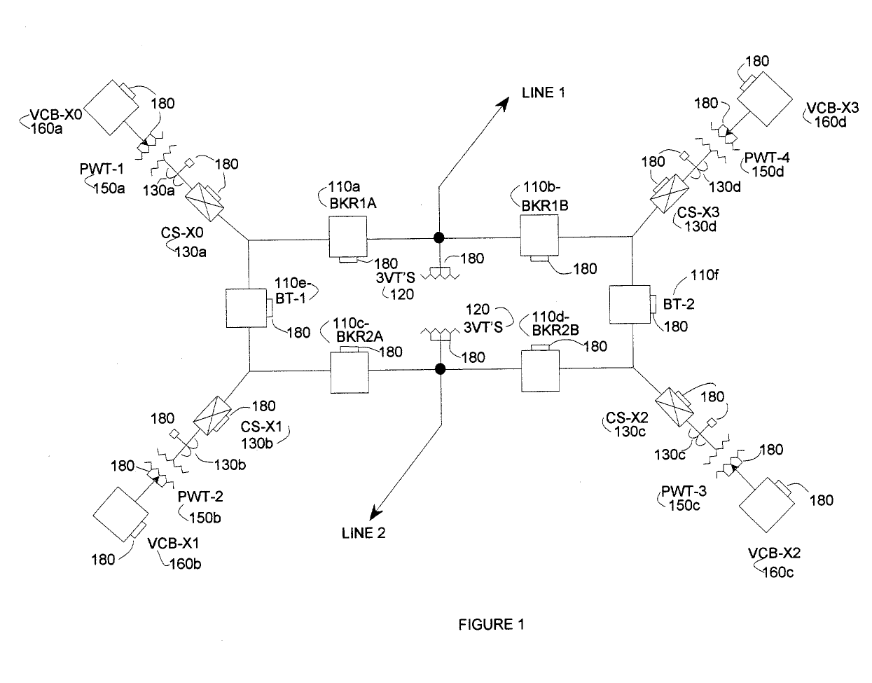

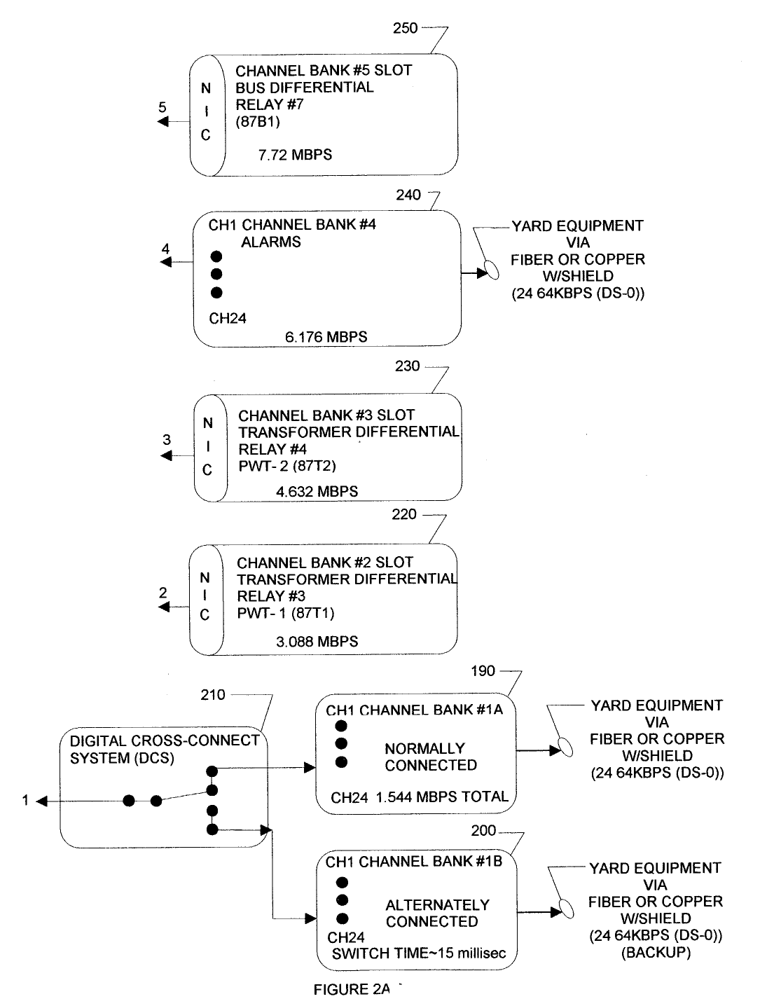

FIG. 1 is a simplex relay one line showing how a channeled WAN would be interfaced to a high voltage system.

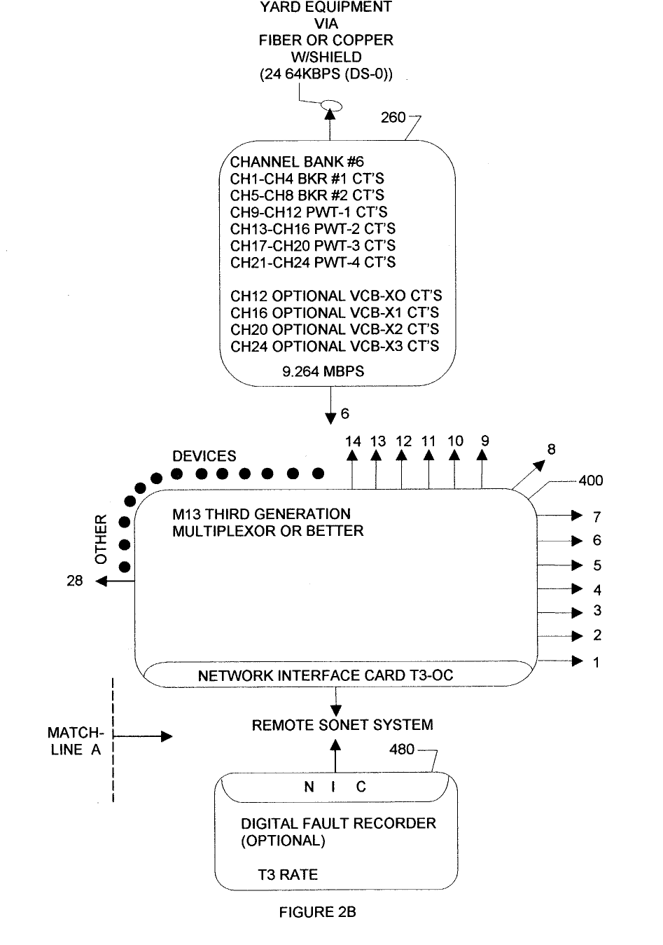

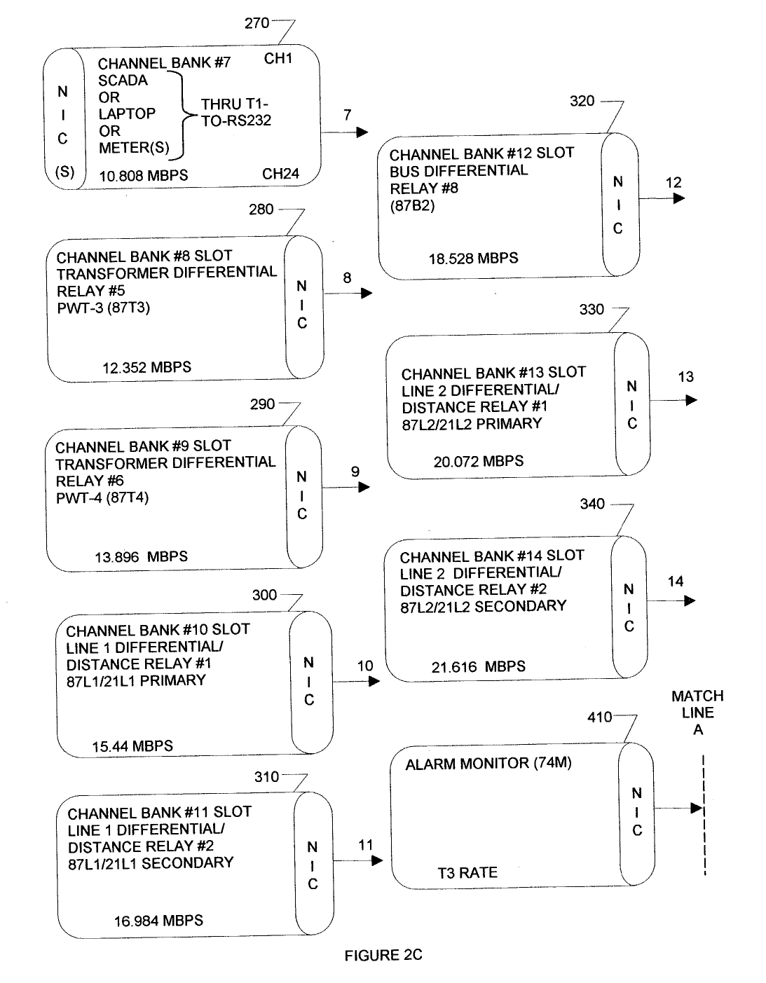

FIG. 2A, 2B and 2C are a simplex WAN with channel assignments, spacing, and equipment employed at a substation.

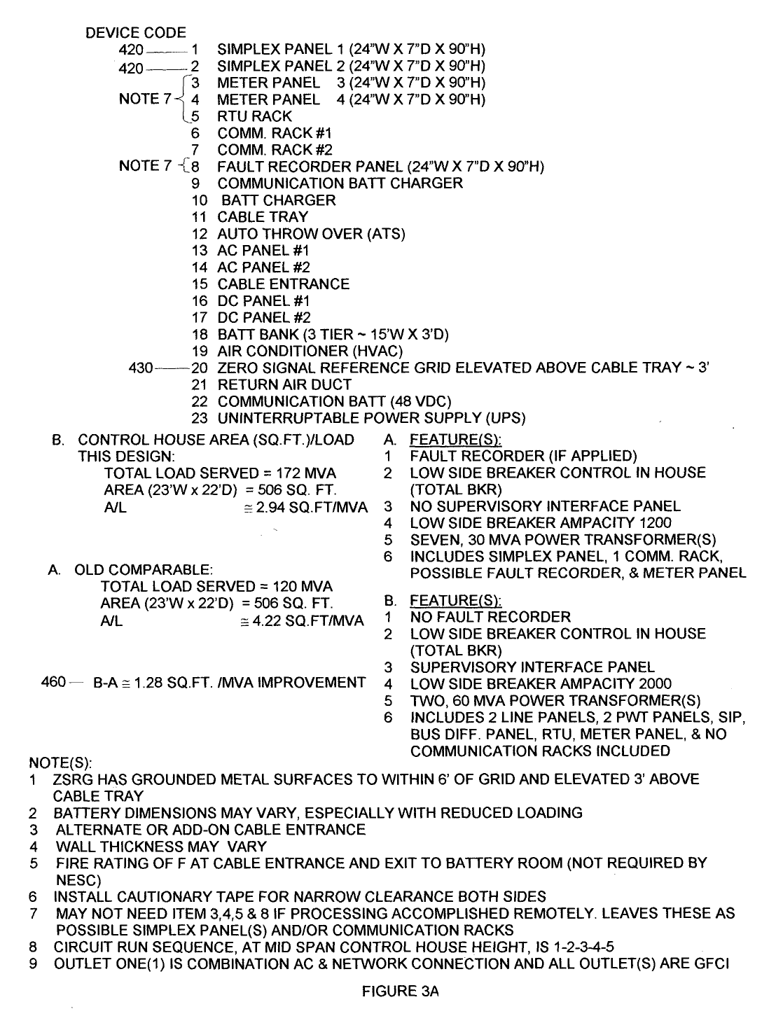

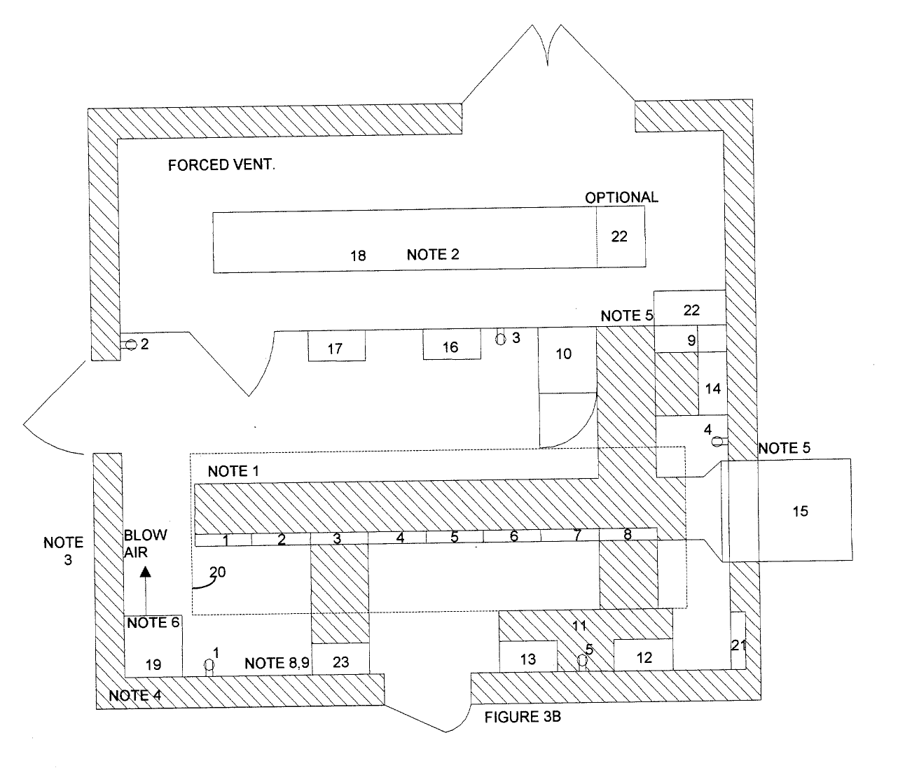

FIG. 3A and 3B are a WAN control house layout showing a comparison between a conventional design and my design.

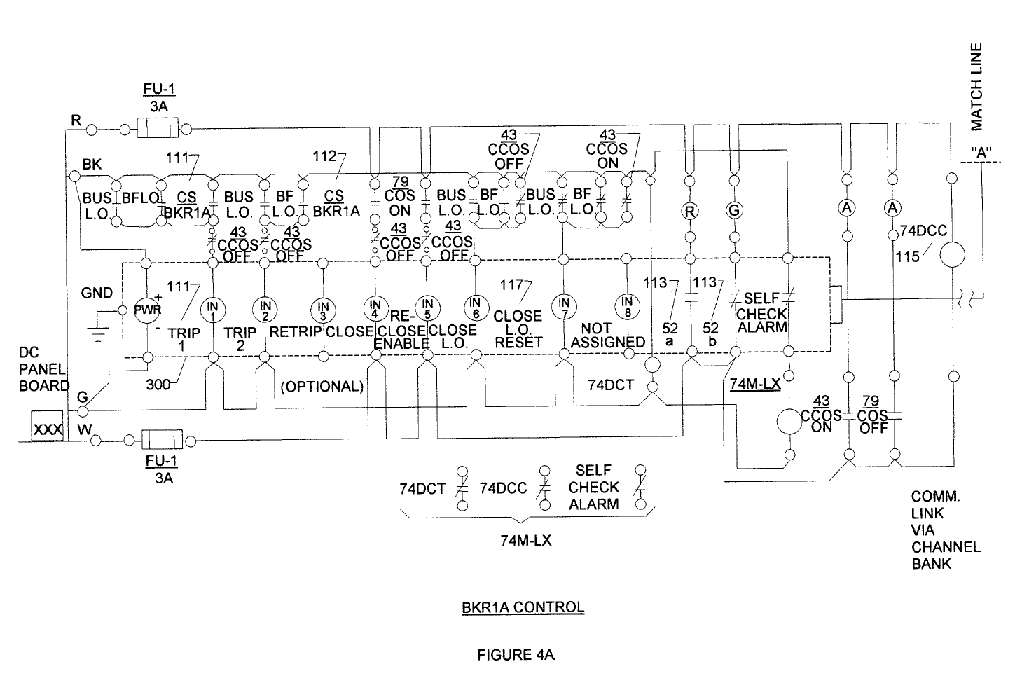

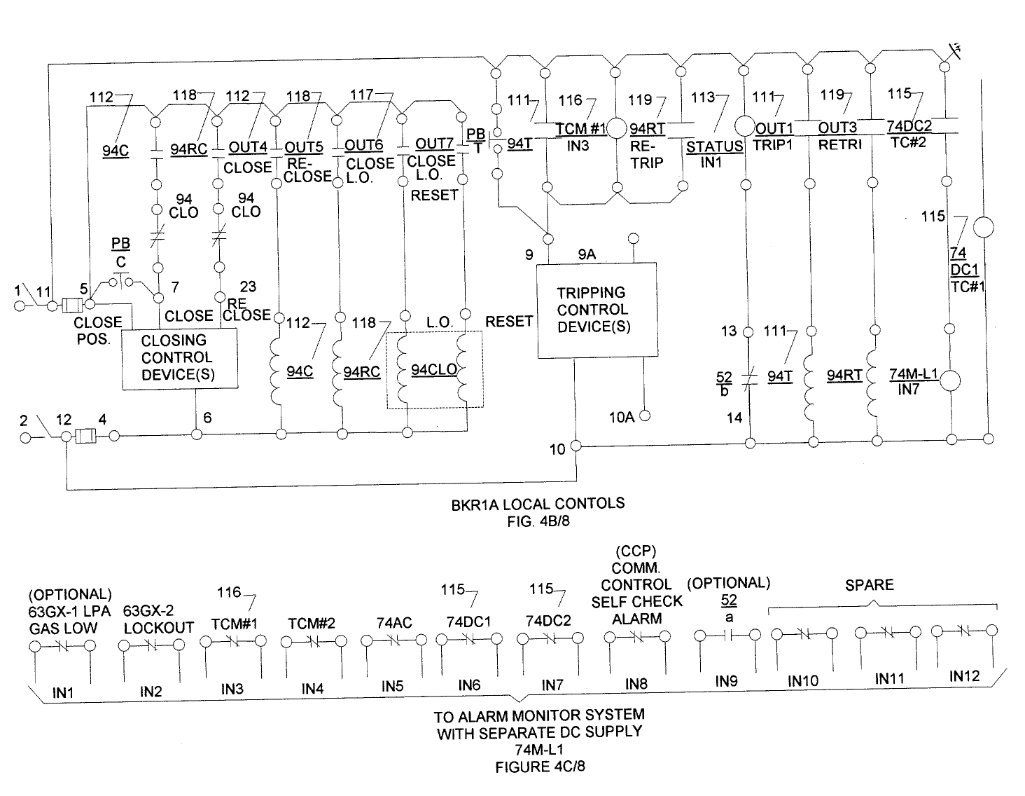

FIG. 4A, 4B, and 4C are a simplex primary control schematic and connection diagram of a breaker control as it relates to this invention.

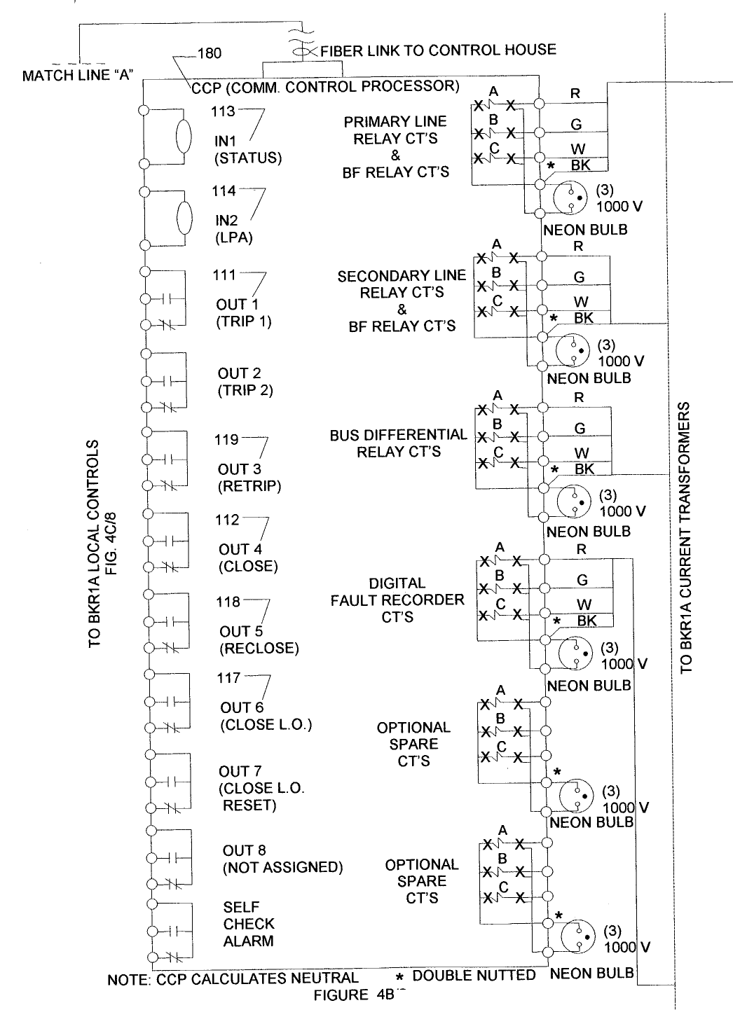

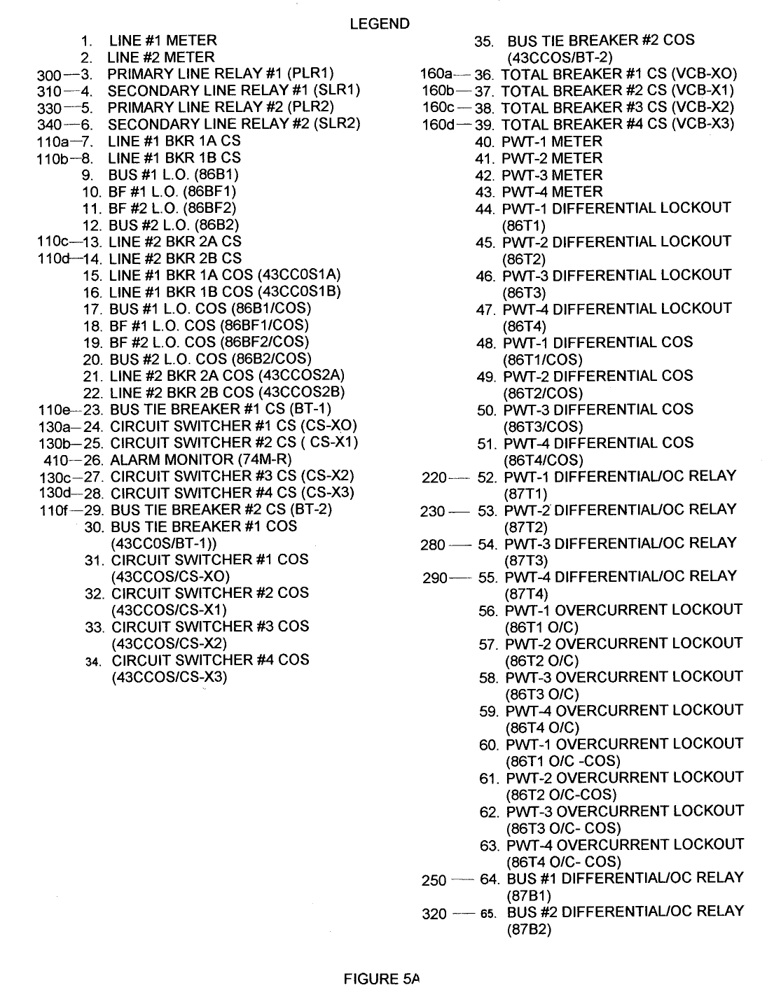

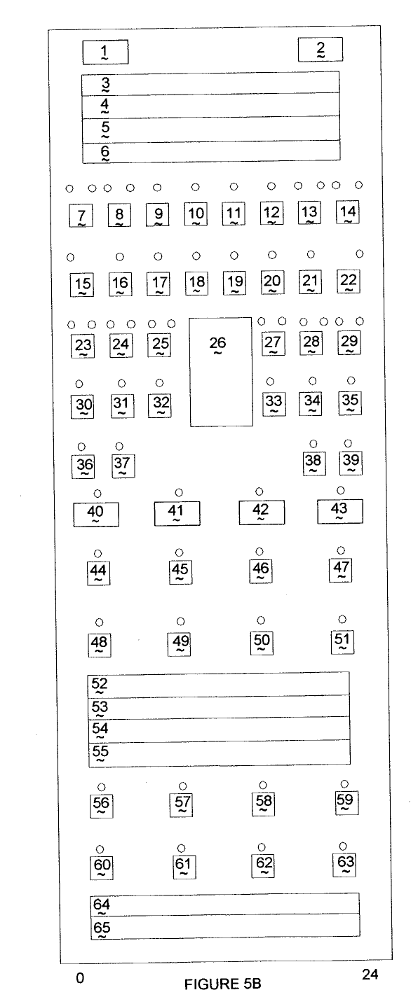

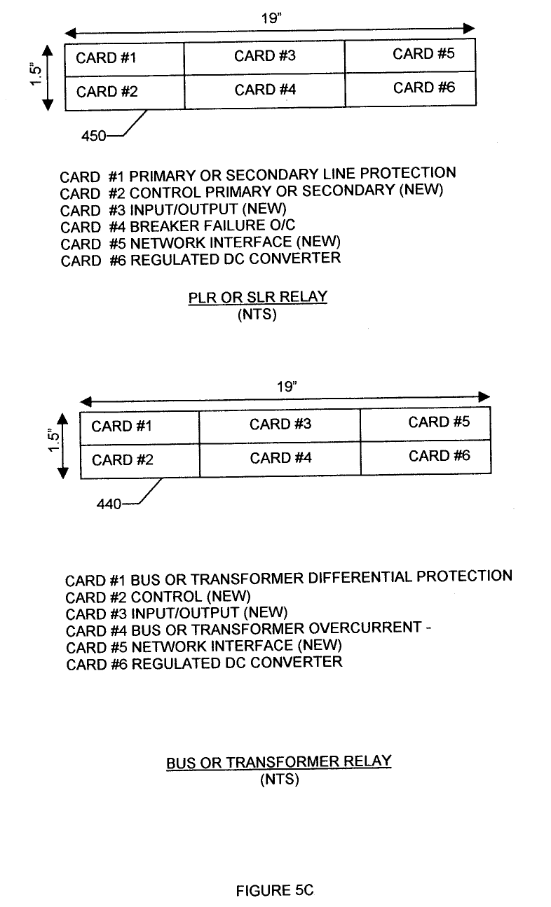

FIG. 5A, 5B, and 5C are a simplex WAN panel assembly layout showing a true simplex system on a simplex panel. It also shows a variant of a conventional relay suited for my invention.

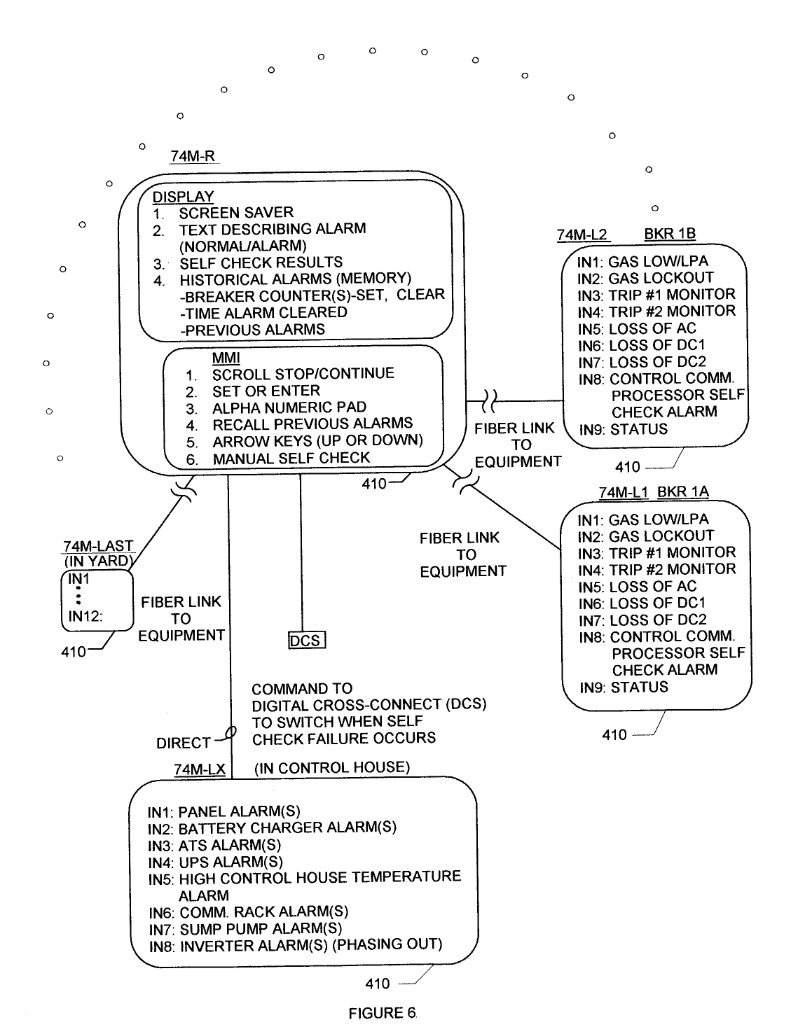

FIG. 6 is a simplex WAN alarm monitor system.

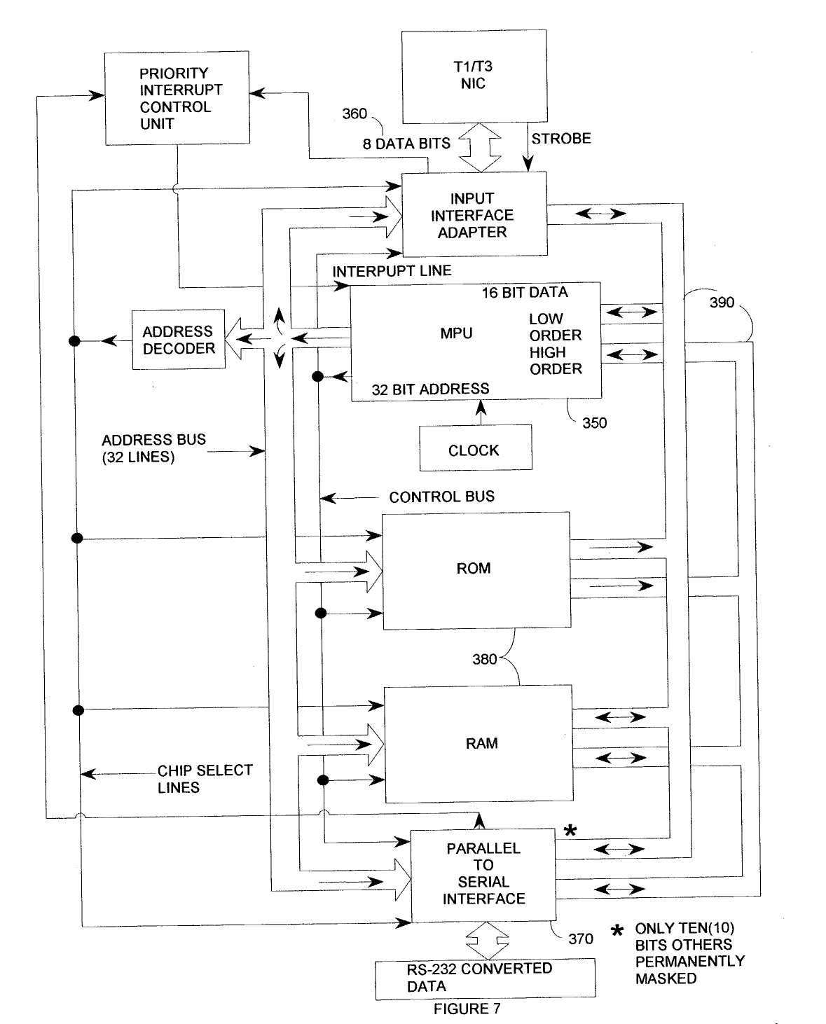

FIG. 7 is a T1/T3 protocol to RS-232 serial interface converter that can be used where needed in my invention.

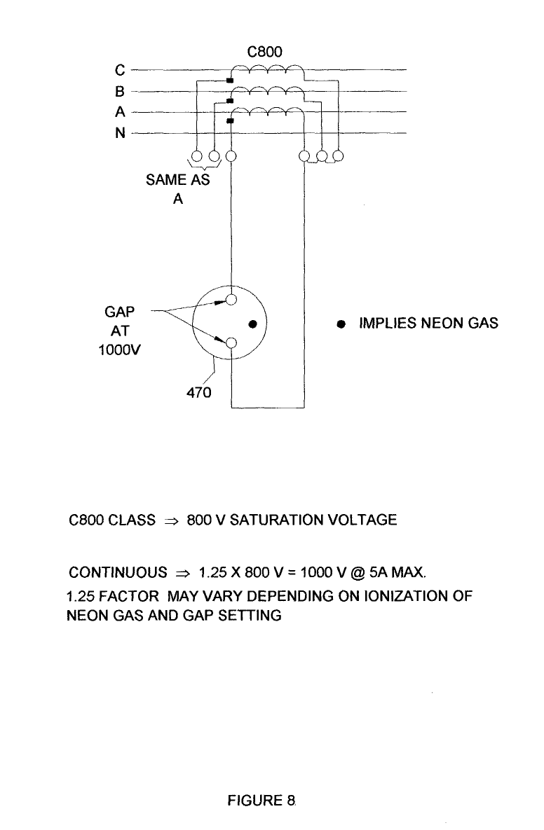

FIG. 8 is a voltage limiter that can be used in case an open circuit occurs on a current transformer circuit.

### REFERENCE NUMERALS IN DRAWINGS

110 Line or Tie Breakers (a, b, c, d, e, & f)

111 Trip signal number 1

112 Close signal

113 Status signal

114 Low Pressure Alarm

115 Loss of DC

116 Trip coil #1 monitor

117 Lockout close signal

118 Re-close

119 Re-Trip optional coils 1 or 2

120 Voltage Transformer (VT'S)

130 Circuit Switchers (a, b, c, & d)

140 Current Transformers (a, b, c, & d) (external CT'S)

150 Power Transformers (a, b, c, & d)

160 Total Breakers (a, b, c, & d)

170 Motor Operated Air Switch (optional)

180 Modified Communications Control Processor with OVERCURRENT Element from conventional

190 Channel Bank #1A (CB #1A) To Yard Equipment 110 through 170

200 Channel Bank #1B (CB #1B) To Yard Equipment 110 through 170

210 Digital Cross-Connect (DCS) Digital Switch Between 190 and 200

220 Channel Bank #2 (CB #2) Transformer Differential Relay #3 non-channeled

230 Channel Bank #3 (CB #3) Transformer Differential Relay #4 non-channeled

240 Channel Bank #4 (CB #4) Alarms

250 Channel Bank #5 (CB #5) Bus Differential Relay #7 BUS 1 non-channeled

260 Channel Bank #6 (CB #6) Current Transformers Internal

270 Channel Bank #7 (CB #7) To Existing SCADA/LAPTOP/METERS

280 Channel Bank #8 (CB #8) Transformer Differential Relay #5 non-channeled

290 Channel Bank #9 (CB #9) Transformer Differential Relay #6 non-channeled

300 Channel Bank #10 (CB #10) Line 1 Differential/Distance Relay #1 Primary non-channeled

310 Channel Bank #11 (CB #I1) Line 1 Differential/Distance Relay #2 Secondary non-channeled

320 Channel Bank #12 (CB #12) Bus Differential Relay #8 BUS 2 (optional) non-channeled

330 Channel Bank #13 (CB #13) Line 2 Differential/Distance Relay #1 Primary non-channeled

340 Channel Bank #14 (CB #14) Line 2 Differential/Distance Relay #2 Secondary non-channeled

350 Microcomputer CPU (16-BIT)

360 Input/Output Port from T1/T3 8-BIT Data Bus

370 Input/Output Port to RS-232 Serial Interface

380 CPU Memory (RAM/ROM)

390 8-BIT Split Bus

400 Multiplexor-Third Generation or Better

410 Alarm Monitor Device-74ML (LOCAL, 1-14), 74MR (REMOTE, at Panel)

420 Simplex WAN Panel

430 Zero Signal Reference GRID (ZSRG)

440 Modified Differential/OVERCURRENT Relay from Conventional

450 Modified Line Distance/OVERCURRENT Relay from Conventional

460 Improvement in Square Footage at the Control House/Primary MVA Load

470 OVERVOLTAGE Limiter for Open Current Transformer Secondary

480 Digital Fault Recorder at the T3 Rate non-channeled

490 Other system components not referenced in drawings, but shown for their relevance

### DETAILED DESCRIPTION

### Description—FIGS. 1 through 5C—Preferred Embodiment

The preferred embodiment showing a system overview of the simplex WAN in the high voltage switchyard is shown in FIG. 1. This shows a relatively standard relay one line with a Line coming in and one Line leaving and devices Breakers 110 through Motor Operated Switch (optional) 170 connected to the 138 kV bus. FIG. 1 also shows at each device Breakers 110 through Motor Operated Switch (optional) 170 a device Modified Communication Control Processor 180.

FIG. 2A, 2B and 2C show devices Channel Bank #1A 190 through Channel Bank #14 340 all connected to device Multiplexor 400 which is also connected to device Digital Fault Recorder 480, device Alarm Monitor-74MR 410, and remotely to another site through an optical carrier system, SONET.

FIG. 3A and 3B show a usual control house with device Simplex WAN Panel 420 placement and the required device Zero Signal Reference GRID 430 because of total digital solution. FIG. 3A and 3B also shows a comparison between conventional design and my new design invention and this item is listed in Improvement in Square Footage/Load Served at the Control House 460. NOTE: Design of conventional design assumed known to examiner.

FIG. 4A, 4B, and 4C show controls for device Breakers 110 showing primary controls derived from the usual controls scheme, however, split via the optical fiber communication link to the Modified Communications Control Processor 180. The breaker controls are restricted to the local breaker area and the Simplex WAN Panel 420 controls are restricted to the control house. Device OVERVOLTAGE Limiter 470 is shown attached to current input to Modified Communications Control Processor 180. Device OVERVOLTAGE Limiter 470 is best located near a Current Transformer 140 secondary, placed in this case, at the breaker current transformer.

FIG. 5A, 5B, and 5C show a Simplex WAN Panel 420 assembly with all simplex system protection, metering and controls of device Breakers 110 through Motor Operated Switch (optional) 170 listed. A Modified Differential/OVERCURRENT Relay 440 and a Modified Line Distance/OVERCURRENT Relay 450 is also shown in FIG. 5C. It describes their distinct card differences from conventional.

### FIGS. 6 through 8—Additional Embodiments

FIG. 6 shows an alarm monitor system with an Alarm Monitor Device-74ML (LOCAL, 1-14), 74MR (REMOTE, at panel) 410 and a separate optical fiber link through Channel Bank #4 240 to every switchyard equipment Breakers 110 through Motor Operated Switch (optional) 170. The Alarm Monitor Device-74MR (REMOTE, at Panel) partial 410 shows a Control Line to the Digital Cross-Connect 210, which will translate through the Multiplexor 400 for control of fiber path in the event of communication failure.

FIG. 7 shows a Microcomputer system with a CPU 350, an Input/Output Port from T1/T3 8-BIT Data Bus 360, and Input/Output Port to RS-232 Serial Interface 370, CPU Memory 380, and an 8-BIT Split Bus 390 to carry the shifted information with the proper format for RS-232 Communication.

FIG. 8 shows a 1000 Volt Limiter 470 with two electrodes gapped, in a glass envelope filled with a neon gas.

### Operation—FIGS. 1 through 5C

A Modified Communications Control Processor 180 FIG. 1 will digitize all current, voltage and DC control at the each device Breakers 110 through Motor Operated Switch (optional) 170 into a T1.105 series optical fiber protocol that will be processed via Multiplexor 400 FIGS. 2A, 2B, and 2C.

Multiplexor 400, FIGS. 2A, 2B, and 2C, is at least a third generation device that has network processing capabilities. Channel Bank #A 190, used to connect controls from devices Breakers 110 through Motor Operated Switch 170 FIG. 1 to the WAN, is the primary optical fiber path for communications. Channel Bank #1B 200 is connected similar as #1A 190, but is an alternate optical fiber path switched by the Digital Cross-Connect 210 device. This switch takes place in approximately 15 cycles to direct switchyard devices Breakers 110 through Motor Operated Switch (optional) 170 to their requested device Channel Bank #2 220 through Channel Bank #14 340 if the Alarm Monitor Device-74ML and -74MR system 410 detects a communications failure from the primary optical fiber path. Modified Communications Control Processor 180 will have a simple OVERCURRENT element to be switched into operation by a manual cutout contact at the Simplex WAN Panel that is derived from Breakers 110 or Circuit Switchers 130. FIGS. 2A, 2B and 2C show a channel assignment for equipment in the switchyard devices Breakers 110 through Motor Operated Switch (optional) 170. Each frequency will allow synchronous communication through optical fiber (preferred embodiment) or copper (#22 AWG) wires.

Presently, copper (#12 or #10) is used for the control conductors except in long runs where larger conductor is used. This is because voltage drop necessitates a larger wire size. By using what is shown in FIGS. 2A 2B, and 2C, this invention eliminates all but supply (AC & DC) conductors. Even VT'S 120 or CT'S 140 FIG. 1, external or internal, can be digitized at the equipment and sent via the communication link to the appropriate devices in the control house Channel Banks #2 220 through #14 340 excluding #4 240, and #7 270 FIGS. 2A, 2B, and 2C.

Relays devices 220, 230, 250 and 280 through 340, in FIGS. 2A, 2B, 2C, 4A, 4B, 4C, 5A, 5B and 5C will also send control signals to yard equipment devices 110 through 170 FIG. 1. For example, in FIGS. 4A, 4B, and 4C a relay 300 and 310 or 330 and 340 combined with an integrated control system, that is, a relay for protection with a modification to include; control card, network interface card, and input/output card can be used to operate a line breaker or two 110 FIG. 1. Whether the relay & control system is differential or distance or over-current or other, FIGS. 2A and 2B show how each yard equipment 110 through 170 FIG. 1 will be interfaced to the remainder of the WAN.

Control devices for 110 through 170 FIG. 1 at the Simplex WAN Panel 420 FIGS. 3A and 3B require one (1) ampere continuous to withstand and much less control contacts. Therefore, more devices can be mounted in less space on the Simplex WAN Panel 420. FIG. 1 shows what I call a simplex design (based on the primary amperes of 900 ampere conductor at 138 kv for one line) on a simplex panel for the whole substation protection. FIGS. 5A, 5B, and 5C show a modified protection relay 300 or 310 for line 1 and 330 or 340 that could be used for primary or secondary line protection with six (6) cards as follows:

1). Primary or secondary line protection card

2). Control primary or secondary card

3). Input/output card

4). Breaker-failure card

5). Network interface card

6). Regulated DC converter card

The relay will be a standard nineteen inches by one and one-half inches. The reason it is small is because the AC system is left in the yard then digitized and transmitted. A replacement card 1, consisting of a bus or transformer differential relay card, can be used. An over-current card can replace card 4 and a control card, for the application, to replace card 2 can be switched. The input/output card will interface the panel's low amperes, low contacts manual controls to the LAN or WAN FIG. 4C. To devices Breakers 110 through Motor Operated Air Switch 170 on FIG. 1 would be a conduit entrance for one or two supply cables and some communications links. The simplex panel would require a zero signal reference grid (ZSRG) 430 FIG. 3A and 3B located just above the panel near the other cables. As an example of the signals to be functional for breaker controls, I use an 8-bit payload area of a T1.105 series byte synchronized protocol signal for the WAN (switchyard and possible plant through other devices on Multiplexor 400). This signal is then multiplexed to 28 T1 rate DS1s signals, of which one is cross-connected by DCS 210 FIG. 2A to two (2) 24 DS0 channel banks. These two consists of a normal fiber and an alternate fiber link for maintenance or communication failure. Two (2) other fibers are used, one for alarms and another for CT'S FIGS. 2A, 2B, and 2C. The payload for a 1 DSO (breaker controls) 110 FIG. 1 can be coded into the following signals:

| 1). | Trip signal number 1 | | (111) |
|---|---|---|---|
| 2). | Trip signal number 2 (Not used this case) | | |
| 3). | Close signal | | (112) |
| 4). | Status signal | | (113) |
| 5). | Alarms (optional) | | |
| | A). | Gas low | |
| | B). | Gas lockout | |
| | C). | Low pressure | (114) |
| | D). | Loss of AC | |
| | E). | Loss of DC | (115) |
| | F). | Trip coil #1 monitor | (116) |
| | G). | Trip coil #2 monitor | |

| | | |
|---|---|---|
| 6). | Lockout close signal - much like | (117) |
| | the software lockout on net- | |
| | worked computers, but initiated | |
| | by a manual control | |

| | | |
|---|---|---|
| 7). | CT-1X (140, FIG. 1) | |
| 8). | CT-2X (140) | |
| 9). | CT-3X (140) | |
| 10). | CT-4X (140) | |
| 11). | CT-5X (140) | |
| 12). | CT-6X (140) | |
| 13). | Re-close | (118) |
| 14). | Re-Trip optional coils 1 or 2 | (119) |

Out of these 1, 2, 3, 6, 13 and 14 are receiving signals and the remainder with 4 and 5 as optional are transmitting. These 140 CT'S are all external and on channel bank #1A or #1B 190 or 200 and can be integrated as part of these banks. A priority transmitting processing will take place of fault elements over status and alarms in this case to ensure control priority. Putting all internal CT'S 260 on a separate channel bank #6 260 from the Communication Control Processor 180, to include separate fiber, will ensure a reliable system. Receive and transmit signals are each 64 KBPS. Therefore, there is plenty of payload space to allow these signals. This payload will encompass the coded control signals and will have its' own individual time slot with respect to the WAN. The time limited signal, that is, the transmitter will send an update under a time limit within the given synchronous time slot and will be remembered as a previous state at the receiving equipment such as 250 or 320 will be referenced to a system clock kept by each device 110 through 170. This time stamp will allow each device 110 through 170 to time error check every function and send an alarm if the update time is in error. Further, in a bus differential system one relay 250 or 320 will address, in this case, two breakers 110 FIG. 1 and three circuit switchers 130 FIG. 1 from its' control card in their appropriate time slot. Sudden pressure relay in a transformer can address this differential relay and it in-turn the appropriate equipment 130 FIG. 1. In all relay applications fault elements will override status or alarms in a priority interrupt fashion from the devices 110 through 170 transmitting signals if that option is used. This means that status and alarms will be an option to Communications Control Processor 180. The update will occur in a time frame outside of which the system will issue an outside time frame error for the control, status and alarms. This will ensure an efficient optical network performing optimal updates to reduce to only necessary transmissions.

### Operation—FIGS. 6 through 8

The Alarm Monitor Device-74MR (REMOTE, at panel) 410 FIG. 6 will do the following:

1) Will operate at 43.232 MBPS selectable

2) Will be able to address every device on WAN on command

3) Device(s) 74ML (1-14) 410 will input a contact from device(s) alarms local to the device(s) to the 74MR, including a self checking contact that will initiate a DCS 210 automatic switch from Channel Bank #1A 190 to #1B 200 from 74MR through Multiplexor 400 in a failure of self check

4) Will be able to self check system on command

5) Will annunciate on monitor and issue a remote alarm where programmed and operate as a station annunciator

6) Will have a reduced input for alarms on Simplex WAN Panel 420

7) Will have separate cabling or fiber than control and indication

8) Will input breaker counter information from 74ML (1-14) device(s) 110 and 130

9) Will input trip coil monitors from device(s) 110 and 130

10) Will have a five (5) inch screen with man/machine interface and an RS-232 Port in front.

In FIG. 7 is shown a converter that will be applied throughout my system where a T1/T3 protocol to the familiar serial interface RS-232 is needed. Microcomputer CPU 350 will respond to input/output port 360 that is a low order 8-BIT Data Bus. This word will be stored in 380 CPU Memory by the processor 350. A word 16-BIT containing the required 10-BIT for RS-232 control will be stored in a register from memory 380. This system will have an 8-BIT Split Bus 390 that will see the 8-BIT Data Bus and the 2 bits from logically ANDING from 380 CPU Memory 16-BIT word and 8-BIT Data Bus. The CPU 380 will then perform the ANDING and output 10-BIT to the parallel to serial converter. This can then be processed serially.

FIG. 8 shows device 470 OVERVOLTAGE Limiter used to limit over-voltage when a current transformer has unintentionally been left open. The rating of this device will vary and be established by allowing the saturation voltage to be maintained with no interference and the neon gas only conducting when the over-voltage is present. If, for example, this current transformer in question is a class 800 relaying CT and it's at its' full tap with 800 volts saturation. I could allow 125% of saturation voltage which would give me 1000 volts. This device will then limit and conduct current only when there would be possible damage to equipment or personnel. This device, by the neon gas, will also give a visual indication to personnel.

### Conclusion, Ramifications, and Scope

Also, since the current and potential signals will be digitized the only place you would need a fault recorder 480 is at the control center. Since the triggers will be done digitally, there would be no need for shunts (usually larger part of equipment). Digital triggers, for example, for fault elements, much like relay elements, are picked up based on a digital number representing an analogue number. Since microwave delay, for example, is 186 miles/1 m-sec and copper delay is 12 miles/1 m-sec there will have to be time synchronization both at the remote substation and control center to compensate for the delay. This implies communication with other devices at the substation such as through a laptop or SCADA or meters via network interface to a channel bank as shown in FIG. 2B 270. This document describes a Communications Control Processor 180 without an analogue input for density monitoring at breakers 110, however, one could be provided. Using fiber instead of copper (#22) would give transient immunity for communication control conductors. The following benefits will occur:

1). Less space requirements for equipment in control houses

2). Less conduit & cable requirements to equipment

3). Easier install

4). Small control device footprint

5). Easy interface to existing equipment

6). Less status contacts in breakers/switchers

7). Better location for fault recorder

8). Transient signal immunity for control conductors—fiber only

9). Overall more reliable system errors 1 in 10 to the twelfth for fiber and 1 in 10 to the sixth for copper

However, copper can be used along with the standard spark gaps and a design to include a separate Transient Voltage Suppression Device located at the supply entrance for the communications equipment Uninterruptible Power Supply. This will include proper system grounding and small K-Factor transformer for non-linear loading that will be small. When equipment is installed in yard equipment device(s) they can be mounted on shock absorbers to lessen vibration interference from switching device(s). Also, an interface device can be designed to allow existing SCADA control to marry my new designed control system. In this way subsystems consisting of partially my new design and partially existing designs can be implemented when an upgrade is desired. To extend the life and reduce maintenance in digital systems from leaky capacitors they will be replaced with solid-state capacitance devices with equivalent capacity. Power Line Carrier equipment can be interfaced very easily to my new system. This system idea can be applied at the Generation, Transmission, Distribution levels and commercial use. This use of controls can be applied to shipboard cabling and generally all apparatus where digital controls are applicable.

1) Multiplexor, Digital Cross Connect, & Channel Banks, shown on drawings as T-3, T-1, will include DS-3, DS-1, and right down to VT1.5 DS-0 SONET levels using such equipment:

2) Device 410 74MR will include any modifications, such as simulations software for testing the entire network during which output controls will be driven inoperable. Or video at OC-3c level for monitoring.

3) Included are device(s) in this network where variations in mounting, such as shock absorbers, quick disconnect for fast replacement, packaging, with physical interface changes such as hardwired cannon plug for quick disconnect exist.

4) Included are any device(s) translating SONET protocols to satellite signal formatting for site to site communications in manifesting this design.

5) Included are any variations in network topology.

6) Included are any uses of any devices shown here in retrofits of any kind.

7) Included are any designs and equipment related to this concept of design.

8) Included use of Device 470 is in any area where voltage suppression is required, such as a voltage transformer circuit.
